(19) United States
(12) Patent Application Publication
(10) Pub. No.: US 2014/0314327 A1
(43) Pub. Date: Oct. 23, 2014

(54) Systems and Methods for Computer Recognition of Plush Toys

(71) Applicant: Build-A-Bear Workshop, Inc., St. Louis, MO (US)

(72) Inventor: Brandon Elliott, St. Charles, MO (US)

(73) Assignee: Build-A-Bear Workshop, Inc., St. Louis, MO (US)

(21) Appl. No.: 14/209,003

(22) Filed: Mar. 13, 2014

Related U.S. Application Data
(60) Provisional application No. 61/780,765, filed on Mar. 13, 2013.

(51) Int. Cl. G06K 9/62

(52) U.S. Cl. CPC G06K 9/6201
USPC 382/209

(57) ABSTRACT

Systems and methods for identifying that a non-digital object, specifically a plush toy, has been brought into the presence of a digital device, which can provide content in reaction to the presence of that plush toy.

### CROSS REFERENCE TO RELATED APPLICATIONS

This application claims benefit of U.S. Provisional Patent Application No. 61/780,765 filed Mar. 13, 2013, the entire disclosure of which is incorporated herein by reference.

### BACKGROUND

1. Field of the Invention

This disclosure relates to systems and methods for detecting the presence of a plush toy and having a digital system react to the presence of a plush toy without the need for the plush toy to be capable of digital communication.

2. Description of the Related Art

As the world has become more advanced, virtually every aspect of human existence has incorporated new technologies. In many respects, toys, generally objects used for play to train children for future life and often designed to be versions of objects used by adults, have been around for much of recorded human history. Because toys are often designed to teach intended behavior, toys have changed as the world has changed to allow for children to play with the type of objects they will experience as they grow older.

Prior to the invention of the telephone, there was no need for toy telephones. Similarly, prior to the invention of the automobile, there were no toy cars or trucks. While the types of toys emulate the environment and era in which children are growing up, toys also have gained increased functionality as the technology of the era has provided for better and safer ways to incorporate functionalities using devices that are often sophisticated machines more so than playthings.

As an example, an early toy telephone may have looked like a telephone, but it generally did not operate like a real telephone. However, as technology has improved, toy telephones have become more like the real thing. From mechanical bells and sounds, to recordings of parts of conversations, to modern toys that incorporate moveable buttons which control computer chips so that the telephone can be manipulated like a real telephone, toys have become increasingly “real”.

One recent advancement in toys is the ability to operate in interactive environments, specifically digital environments such as the Internet or computer simulated worlds. For example, a physical toy may interact with a computer game where the toy is represented by an avatar, may provide for the user to manipulate the toy and have that interaction be translated to an on-screen action, or the toy may move in response to an onscreen indication. Such a toy's digital interaction is generally computer components in the toy and a connection to a computer or other general interactive display device, such as a television. For example, a plush toy may “speak” when it receives a signal from an interactive device, such as a computer or television, in response to a user doing something in an environment presented on the screen. The sounds issued will usually be connected to the activity on the display screen and therefore the toy can appear to interact with what is occurring on the screen.

These interactions are, however, limited in several very important ways. In the first instance, the interactions have traditionally required both the digital machine providing the environment, and the toy, to be digital devices. That is, both digital machine and the toy need to have mutual communication protocols and electronic hardware within them. This can be expensive as, effectively, interactive toys must include a sophisticated machine to allow the toy to appear to interact. Further, such interaction can be power demanding, and changing batteries in a toy can be difficult or annoying. Still further, the inclusion of such devices can ruin the appearance or feel of toy (e.g., a soft plush toy is no longer soft, but now includes a hard chunk of electronics and batteries within it).

Because of the increase in available computing power, the ability to utilize digital control in all types of devices has become more common. However, while digital devices are commonly incorporated as control panels or as internal components of other objects, they generally cannot interact with non-digital devices. Children today are fully able to utilize sophisticated digital computing devices such as “smartphones” and tablet computers and regularly use these devices as toys. Many children are entertained by games, videos, and other content on such devices. However, although they are used as toys, these devices are not toys, strictly speaking. Instead, they are fully functional electronic devices. As such, the line between the toy telephone, and the telephone used as a toy, is becoming increasingly blurred.

Regardless of how advanced computer devices become, some kinds of toys are often best left to the non-digital world. While children may love to play games on tablet computers, most also love to play with wooden blocks and with games that are made with cardboard boards and plastic markers. One type of toy which has generally not benefited from more sophisticated electronics is the plush toy, also commonly known as a teddy bear. A plush toy, as its name suggests, gains much of its desirability as a toy from its texture and appearance. Most plush toys are simple, soft, and non-threatening. As such, electronic components in them tend to reduce their most desirable characteristics.

Further, many parents who have become increasingly concerned about a child's “screen time” may push for children to play with less sophisticated, more hands-on toys. Part of the concern about children having too much screen time is that many digital toys require the child to use less imagination. The use of imagination is virtually inherent in play with non-digital toys. These types of toys are simply incapable of behaving in as complex a fashion as their real life counterparts and children “pretend” that a toy is the real thing. Part of the action of pretending is that the child will often anthropomorphize the toy, giving human traits to an inanimate object. As such, a toy fireman will put out imaginary fires in a bookcase high-rise, and a doll becomes the guest at a lavish tea party.

In recent years, the increase in licensed toys, those based on entertainment content, such as but not limited to Transformers, Star Wars, Iron Man, The Lord of the Rings and My Little Pony, create a hybrid type of toy. The toys are often quite simple in their construction and generally non-digital (at least at lower price points). They may be dolls or action figures of characters in the entertainment content, or may be objects from the entertainment content, such as but not limited to swords or crowns. In fact, a trip to a toy store will show that a huge percentage of toys are either licensed from entertainment content, or have had entertainment content licensed from them.

These “licensed” toys often provide for an ease in anthropomorphizing the toy. For a child who has seen the entertainment content, the child has seen a realm in which the characters and objects of the toys “exist” and thus it is easy to place the toys in that realm in their imagination. This link between entertainment content and non-digital toy is further enhanced through advertisements for toys based on such entertainment as the advertisements often include clips (or even new material) from the entertainment content to make the toy more “real.” Basically, these fictional presentations provide for a story where something fantastic can be real. Children can then obtain the toys based on the story and recreate scenes or write their own stories set in the same fictional universe by anthropomorphizing the toys which represent characters in the story.

Anthropomorphism of toys by children as part of their play is not new. The “reality” of toys as things other than inanimate objects has been fertile ground for children's literature and entertainment for many years and virtually every child, at some time, sees a toy as more than just an object. It has long been recognized that children have a more difficult time separating fantasy from reality than adults and therefore such anthropomorphism is easily understood, particularly when purposefully fed by entertainment content that is built to sell spin-off products as much as to entertain. Further, anthropomorphism of toys can allow a parent to use a child's imagination to assist in dealing with problems created by a child's imagination. Child-rearing books are filled with examples of using a child's plush toy, in a child's imagination, as a powerful hero that can defend the child from a child's imagined “monsters under the bed.”

Particularly when it comes to plush toys, the desire of children to anthropomorphize the toy can be strong. Such toys are very often comfort objects for children and are often used to calm and reassure children. A teddy bear going through an X-ray scanner prior to a child is a common image. Thus, there is often a natural push that plush toys are seen by children as real “people”. This particular anthropomorphism, and the specificity with which it is associated with a particular plush toy, leads to a desire to be able to feed a child's imagination with content for that toy in the same way that toys based on entertainment shows can provide for a ready fictional world.

The problem with providing such content, however, is that a plush toy is often personal to the child. As opposed to the toy being representative of entertainment content (e.g., the toy being “Iron Man” to all children), the “same” toy is “Bobby Bear” to one child and “Joey Bear” to another. Thus, the need to provide entertainment content that is responsive to a plush toy requires the content, even if not unique to a child, to be directed to that child and their specific toy, even if that toy is one of thousands of identical toys.

While many sophisticated plush toys include computer chips as part of their construction to allow interaction with other digital devices, it is often not desirable that a plush toy be a digital device in order to interact. Plush toys often hold their special place precisely because they are not sophisticated digital devices. They are companions and comfort objects. Instead, of having to make a plush toy into a digital toy to be able to interact, it is often desirable to use the ready power and capabilities of a digital device to give the illusion that a non-digital toy is carrying out an action, when instead the action is entirely within the neighboring digital device.

The primary problem with having the device which presents the content also select the content is how to get the digital device (which can provide the content) to recognize what content it needs to provide based on the toy. In many digital devices currently, programs have to be loaded and the digital device does not “react” to the toy, instead the human user provides the feedback with the toy being relatively static. While a child's imagination can often fill in the gaps between the toy and the digital device (e.g., by questioning the toy and typing in the answers), it can be much more fantastic to the child to have the digital device react to the toy without need for such data entry. This is especially true as young children become more used to playing with computers and other digital devices.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein are systems and methods for identifying that a non-digital object, specifically a plush toy, has been brought into the presence of a digital device which can provide content in reaction to the presence of that plush toy.

In an embodiment, there is described a station for providing an interaction with a plush toy, the station comprising: an imaging device; a screen; and a computer having access to a database of plush toys; wherein, when a plush toy is presented to said imaging device, said computer compares said image against said database and locates a match; and wherein, when a match is detected, said screen displays content specific to said plush toy.

In an embodiment, the station further comprises a speaker and, when a match is detected, said speaker vocalizes content specific to said plush toy.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1 provides an embodiment of a retail station that recognizes a plush toy and provides digital response information.

FIG. 2 provides an embodiment of a camera image indicating a portion of a plush toy that the computer has locked-in on.

FIG. 3 provides a conceptual view of certain plush toy elemnts that the computer is using for identification.

### DETAILED DESCRIPTION OF THE PREFERRED EMBODIMENT(S)

The disclosure herein is primarily directed to how to allow a digital device (specifically some form of digital computer) to detect that a particular non-digital object has been brought within its proximity and that it should generate content in the form of screen displays, sounds, outputs to peripherals, or other forms of output that is “reactive” to the non-digital object. The digital device will generally be considered to be part of a “station” which is part of a retail environment, but need not be. Alternatively, it may be for home use. As such, it is simply reactive to certain objects (such as toys) being brought into a particular proximity with itself. However, in an alternative embodiment, the system can be used on a digital device of more general purpose. For example, the system could be in the form of software provided to an owner of a toy which they can use on a computer they use or own. The computer (connected to an imaging device) can then present the same material locally to the user.

In the present disclosure, the non-digital object will generally be a plush toy. Although the toy may include various digital components, e.g., a sound chip with recorded sounds thereon, and may even include sophisticated microprocessors and other digital components, the detection of the presence of the object will generally not utilize these devices and these devices will not be necessary for the toy to be detected. Thus, it is not necessary for the object to “promote” its existence to another digital device. An example of such promotion is the Bluetooth™ standard which allows any digital device to announce its presence (and seek to connect with) other devices using the same standard.

The reason for not wanting to rely on such promotion standards is multifold. For one, these types of notification systems can be quite power intensive and smartphones, headsets, and other devices that use such promotion standards often require daily (if not more frequent) recharging. Recharging of a power pack in a plush toy can be difficult and often requires the toy to include wires or connectors that can reduce its desirability. It also can make it hard to wash. Thus, in order to preserve what may be a relatively limited battery life on the digital device, one would generally not want the plush toy system to use power simply in order to be detected.

Secondly, such promotion systems generally require security settings to make sure information is not captured by those with bad or deceptive intentions. For example, Bluetooth™ requires an “offer and accept” form of communication. Particularly when it comes to children, one generally does not want to have to rely on a toy having the proper or correct security settings to protect potentially sensitive information about the child, or to rely on a child to not accept a request they should not accept. Children already face a great number of threats simply by being children and the purposeful broadcast of information about these children from a toy is clearly not desirable. Thus, it is preferred that the station be able to detect that a toy is present, without the toy specifically announcing its presence to the station.

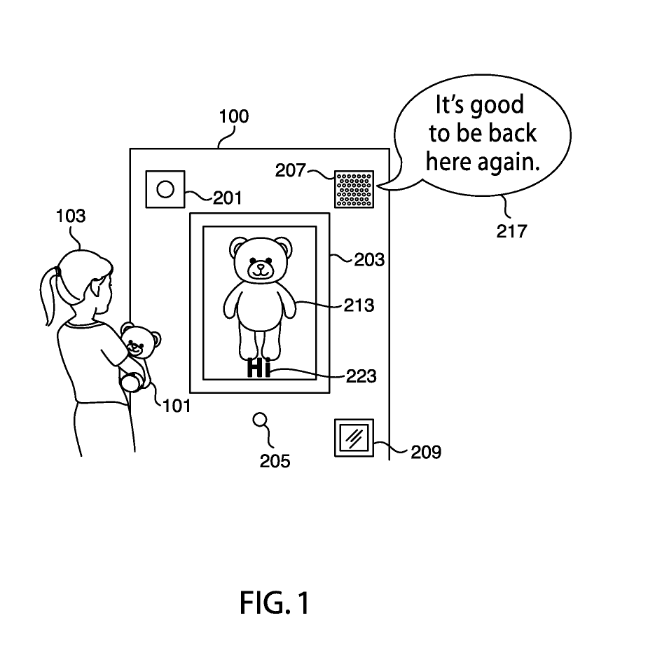

FIG. 1 provides an embodiment of a retail kiosk or similar device, called a station (100) herein, which may be part of a retail store and used for the detection of a particular toy. Generally, the retail store where such a station (100) will be used is one where a limited number of different types of plush toys (101) will be sold, or have been sold, over time. One such example is a Build-a-Bear Workshop® where individuals can come in and assemble plush toys (101) to their own specifications (within certain limitations). In such a retail environment, the station (100) is designed to detect the presence of a plush toy (101) that was previously sold by the retail store, and therefore will give an incentive for people to return to interact with the station (100). For example, if a child (103) has the toy (101) with them and is near the store, the child (103) may wish to go to the store to interact with the station (100) because the interaction is fun and it provides entertainment content based on the toy (101) that is not otherwise available. This could result in them making a purchase in the store, such as new clothing for the toy (101).

In the embodiments discussed herein, the presence of a toy (101) is determined through the use of machine “visual” recognition. Specifically, the station (100) will include a scanner, camera, imager, or some other form of imaging device (201). In this case, the imaging device (201) is a digital video camera but other devices could be used. Once the station (100) is activated, this imaging device (201) will be scanning a particular area (in this case immediately in front of the station (100)) to look for toys (101). The imaging device (201) is connected to a computer, which in the embodiment of FIG. 1 is hidden within the station's (100) housing.

The computer is of a standard type understood by those of ordinary skill in the art and may include various pieces of computer hardware including, but not limited to, digital processors, display devices, input devices, local storage, and communication hardware. It may have software to implement the functionality discussed below. The computer is preferably concealed in the station's (100) housing to enhance the illusion that data is not collected (as would be the case when the recognition system was part of a retail environment or storefront). Alternatively, it should be recognized that a software embodiment of a recognition system could be running on an obvious computer device, such as, but not limited to, a home desktop computer, laptop computer, or a tablet computer.

It is generally preferred, that traditional computer interface devices (e.g., keyboards and pointing tools such as a mouse) be hidden from the child (103) in the station (100) and that any interface with the computer occur through an interactive touchscreen (203). The screen (203) may therefore provide output to the child (103) and can also act to take in input from the child (103). As the station (100) is designed to look reactive, it is generally less preferred that data be entered in a traditional looking way and the need to utilize traditional computer interface tools is eliminated to the extent possible.

The computer controlling the recognition will often be in communication with other computers which could include other computers in a retail environment, and may be in communication with remote computing tools such as storage devices and more powerful network machines in a manner well known to those of ordinary skill in the art. There may also be in communication with other networks such as, but not limited to, the Internet. These types of networks of computers are well understood by those of ordinary skill in the art and one of ordinary skill in the art would understand how various functions of the system can be shared across such a network.

In an embodiment of the system, a child (103) will approach the system (100) with a plush toy (101). The presence or arrival of the child may be detected, e.g., through a motion sensor (205) which activates when motion in the effective field of view of the imaging device (201) is detected. Thus, the imaging device (201) may be powered down and the computer is not trying to recognize a static display when recognition is clearly not needed. The approach of child (103) triggers the motion sensor (205) which then activates the imaging device (201) to search. Prior to a child's (103) approach, the screen (203) will typically display cues to those nearby to bring their toys (101) to the station (100).

Once the motion sensor (205) detects a presence, the screen (203) may change to encourage the child (103) to hold up their toy (101) or otherwise present it to the imaging device (201). While this may not actually be necessary for the toy (101) to be detected and recognized, it may provide more time for the computer to scan the database and identify the toy (101) and may provide for a clearer image of the toy (101) reducing the possibility of a misidentification. The screen (203) may display various screen displays such as a scanning line, the swing arm appearance of a backscatter X-ray machine from the airport, or other well recognized technology which would indicate that the system is working. Alternatively, the screen (203) could simply respond.

It should be recognized that, in certain embodiments, the above screen (203) displays are not necessary. For example, the station (100) may be able to identify the toy (101) within seconds of the motion detector (205) being activated and all of these displays may simply be to enhance the play value of the station (100). Once the imaging device (201) has detected that the child (103) is holding a toy (101), it will attempt to “lock-in” to the toy (101) and track the toy (101) as it moves within the imaging device's (201) field of view. This allows the system to continue processing the toy (101), even if the child is moving it and provides for improved likelihood of correct recognition. Further, it can detect a scenario where the toy (101) leaves and another toy (101) is provided versus when a second toy (101) is presented simultaneously.

Once the imaging device (201) has obtained an image of the toy (101), the imaging device (201) will compare the image against a database of known toys (101) to determine if a match can be found. If a match is found, content based on the match can be presented on the screen (203). For example, the screen (203) might display a stock picture or animation (213) of the particular plush toy (101) or may provide a visual greeting of interaction (223) to the toy. In a still alternative embodiment, the station (100) may give voice to the toy (101) through an included speaker (207). These things can all work together so that, upon recognition of the toy (101), an animation (213), visual greeting (223), and sound (217) may all be used simultaneously. Thus, the station (100) will appear to recognize the toy (101) and the toy (101) will appear to respond on screen (203) without any form of obvious data input from the child (103).

Because the toy (101) is identified based on the specific version of toy (101) that the store sold (e.g., it is a pink dog) the content can be specifically geared for that particular version of toy (101). For example, because the toy (101) is a dog, the “speech” of the toy may include a more animal growl in its sounds (217), or may include a periodic “woof.” Similarly, the toy (101) may generally intended to be more “female” (e.g., because of its pink color) and the voice (217) may be more feminine.

Similarly, because the toy (101) is generally of a fixed version (that is, the pink dog toy is a toy with a large number of similar copies), it is possible to carry the illusion of the toy (101) speaking through a variety of different stations (100) or devices that detect the toy. For example, if the software running the station (100) is also be provided in a home use form (e.g., as a downloadable “App” for a smartphone) that the user can use at home, when the toy is detected on that device, the same screen image (213) and voice (217) can be used for the same toy (101). This gives an appearance of consistency and that the screen image (213) and voice (217) belong to the toy (101). These images (213) and voices (217) can also be maintained in purely digital content. For example, if the toy manufacturer provides for a virtual world that the toys (101) can populate, then the avatar of the toy (101) may match the screen image (213). For example, for a plush toy created at a Build-a-Bear Workshop®, the screen image (213) may be the toy's avatar from Bearville.com®.

For a station (100) in a retail environment, it may be preferable to provide for a variety written (223) or spoken (217) content so that the same content is not presented to multiple children in succession who may have the same version of toy (101). As was indicated earlier, plush toys (101) often are specific to a child (103) even if there are thousands of generally identical toys made. Each child's (103) copy of the toy (101) is a different “person” than another child's toy, even though they may be physically identical. In order to not spoil the illusion of reacting to the specific toy (101) for this child (103), written (223) or spoken (217) content may be randomized or semi-randomized so that each interaction is separated by other different interactions even if the same toy (101) is repeatedly presented. As should be apparent, such breadth of communication provides for an improved illusion that the station (100) is presenting content directly related to this toy (101).

In a still further embodiment, the personalization may be further enhanced by having the child (103) be identified by the station (100). Generally this will not occur using the imaging device (201), but through a scanner (209) or similar input device. This scanner (209) is for reading machine-readable indicia such as, but not limited to, a standard 2-D bar code, a 3-D bar code, a QR code, or any other machine readable code. In order to identify a child (103), the child (103) may be provided with marketing mailers, emails, or other content which may include such indicia. This material could be to promote a certain item, provided as a reward, or to recognize an event (such as, but not limited to, a birthday). The content could be brought in and scanned by the user, (e.g., from a paper printout or from a screen display on an item such as, but not limited to, a smartphone). In a still further embodiment, the scanner (209) could scan a frequent purchaser card. This could allow for specific information about the user to be displayed and the enhanced reality function to interact with the user individually.

Upon scanning, the station (100) can now identify the child (103) and may obtain a profile for the child (103) from the network. This profile may include information specific to the toy (101). For example, a name of the toy (101) that the child (103) had previously provided. This information may be used as part of the content (223) and (217). Accessing a digital profile for a child (103) and/or toy (101) is discussed in U.S. Provisional Patent Application Ser. No. 61/684,420 and U.S. Utility patent application Ser. No. 13/828,273. The entire disclosure of both these documents is herein incorporated by reference.

Upon identifying the child (103), the station (100) could also present individualized or semi-individualized content. For example, if it is the child's birthday, the station (100) could provide birthday related imagery (223) and wish the user a “happy birthday.” This content is semi-individualized as while it acknowledges a specific event related to that child (103), it is not specific to that child (103) and any child (103) with a time-proximate birthday could receive the identical message, although it may be from a different image (213).

While the above is focused on the general type of interaction that a child (103) may have with the station (100), the below is more focused on how that interaction is triggered. As indicated above, the imaging device (201) will generally be active as the child (103) approaches the imaging device (201). In order for the imaging device (201) to instruct the computer to display appropriate screen (203) content, it is necessary for the computer to be able to 1) identify that a toy (101) is present and 2) identify the version of toy (101) that is present.

As discussed above, the preferred type of toy (101) is a plush toy (101). Such toys are quite common and often strongly anthropomorphized by children. However, identifying the presence of a plush toy (101) requires that a variety of techniques be used. In the first instance, as the system is designed to interact with children (103) with stuffed toys (101), the system may presume that, when the motion sensor (205) is activated, there is likely a child (103) with a toy (101) in the field of view of the imaging device (201). The system may quickly scan for human forms (particularly smaller human forms) and determine if there is such a human form present. If there is, the system may then determine if the human appears to be holding something. Again, if this is true, the system may then examine the held object and perform recognition as discussed herein.

While this is a simple way to identify the presence of a toy (101), the concern is that it is often wrong. In the first instance, the child (103) may be holding a box, a shopping bag, or something else that is not a toy (101) and, if this is identified as a toy (101), the play value of the station (100) is quickly lost. Further, the motion detector (205) may be triggered by a parent, or there may be more than one human in the field of view requiring the system to split its attention. These can all lead to an inaccurate toy (101) detection, which damages the believability of the station (100).

Similarly, as anyone with small children is aware, small children are often very enthusiastic about showing off their toys. Thus, it is highly possible that the child (103) will approach the imaging device (201) quickly and place their toy (101) very close to it (or push it against the screen (203) not knowing where the imaging device (201) is). In this scenario, the field of view of the imaging device (201) may be partially or fully obscured. As such, the imaging device (201) may not be able to detect the child (103) or may not be able to detect that the child (103) is holding something, resulting in the system thinking there is no toy (101) present.

In an alternative embodiment of identification, the detection and recognition of the toy happen together and the recognition can take into account a large variety of variables in how the toy (101) may be presented. There are a number of systems which already exist for pattern matching and identification of particular elements of images. For example, some forms of image recognition are provided in “Fast selecting optimal feature subset for multi-class classification with applications to high dimensional data,” Qiang Cheng, H. Zhou, and J. Cheng, IEEE Trans. Pattern Analysis Machine Intelligence, vol. 33, no. 6, pp. 1217-1233, 2011, the entirety of which is herein incorporated by reference.

These types of image matching software algorithms can be used for a wide variety of matching programs. A concern with such algorithms, however, is that many are focused on accelerating particular types of pattern matching. For example, such algorithms are designed to match faces between photographs quickly. The problem with such systems is that they often rely on similar cues that are common across all the images being reviewed in order to determine how to match. For example, in facial recognition, virtually every face has a large number of common features. For example, it usually has a generally round shape, has two eyes spaced apart and above a central nose and mouth. There are ears on both sides and hair on top. While specifics of these general elements can vary widely, and certain individuals may lack one or two of them, the presence of most or all of these common elements provides for a common framework which the matching system can work within. In facial recognition systems, there are also a huge number of potential faces that could be matches. Thus, many matching systems work from the common framework to match related elements (e.g., by comparing known variables such as the distance between the eyes, the relative size of the nose, etc.) with a high degree of accuracy.

Even outside of facial recognition, many automatic pattern recognition systems that are designed to work on images of other objects are still designed to work within a relatively small number of variables. For example, systems that may scan X-ray photographs to look for broken bones will generally have a certain number of possible bone views to select from as X-rays are typically taken along fixed axes. Thus, the recognition systems are able to rapidly identify the type of image they are looking at (e.g., the bones of a human forearm) and from that can then look for specific anomalies that the system is designed to detect.

The problem with plush toys is that to the extent that they may have common features, those common features may be identical. For example, two bears may have identically laid out eye and nose positions and sizes. Further, while facial recognition can focus on a relatively small part of the body, a plush toy system has to recognize that any particular part (and a defining part) may not be visible at any time. For example, toy recognition software that is designed to match elements of a plush toy's face, is useless if the child (103) holds the toy (101) facing them (as shown in FIG. 1).

Further, plush toys often come in a very wide array of options. Even if the array is limited to a certain number of known toy versions (e.g., 200, 500, or 1000), there may be toys within the array that share and are differentiated by different characteristics. For example, the array may include a number of bears that are all of the same identical shape and size, but come in a variety of different colors. Still further, two bears may be the same color, but may have different textures or may have different textured patches placed on them. Along these same lines two different plush toys may be made of identical fabric, but are in widely different styles, for example one is a bear and one is a dog. Still further, the plush toys may be accompanied by accessories, such as, but not limited to, clothing, which may partially (or even mostly) obscure them. In some cases, the clothing may actually better identify the particular toy than the underlying toy itself. For example, a toy dressed as Darth Vader may be more appropriately responded to or recognized based on its costume rather than being responded to or recognized based on the underlying toy.

As should be apparent from the above, the difficulty in identifying and recognizing a plush toy can arise from needing a significant amount of information about the toy, and possibly having only a portion to work with. Further, as opposed to most pattern recognition where the key is to compare an image against a huge number of possible matches, toy recognition generally has a smaller database of possible matches, but a larger number of variables that may matter.

To deal with this problem, algorithms for traditional comparisons can be modified. For example, in facial recognition, the commonality among faces requires looking at less pronounced features (such as eye spacing) and detecting fine differences. In identification of plush toys, focus on macro variables such as color(s), pattern(s), shape, and distinctive features (for example, the length of its ears) can narrow a possible pool of toys quickly. Further, it is often the case that, while two or three of these variables may be needed to recognize the toy, it may be possible to do so using any small subset of them. At the same time, identical features across toys may provide valuable recognition information but may also serve to provide recognition where there are not identical features.

Consider an example where there are three different toys. The first two are identically shaped bears, but one is pink and one is green, and the third is a rabbit that is an identical green to the second bear. As can be seen from this example, the first toy (pink bear) can be identified by one variable: its color. Similarly, the third animal (green rabbit) can be identified by one variable: its ear length. Within this subset of toys, determining these values is definitive. Further, the second toy (green bear) could be identified by two variables, color and ear length. Thus, for these two variables, all the toys can be definitively determined. However, assume that the animal's head is not visible. The first animal (pink bear) is still definitively identified by its color. The second and third, however, cannot separated by the ear length anymore. However, these animals may have different patterns on their feet (to represent the different paw prints of a bear and a rabbit). Alternatively, they may have different color tails or other identifying features. Thus, with a large enough possible realm of items to be compared, it is relatively easy to recognize any plush toy from among a set with only a couple of variables. Further, in a particularly large set, a single variable may be able to dramatically reduce the number of possibilities quickly.

However, the difficulty can lie not when there are differences between elements, but when there are commonalities. Assume that, for some reason, the color of the animal cannot be determined. In this case, all data for either bear will point to the same bear. Thus, while the one variable (color) can go a long way to determining the specific toy presented (even to the point of identifying it definitively), the inability to get that one variable may be a complete bar to recognition because, effectively, each answer may be equally likely regardless of how many other variables can be determined. There may be twenty clear elements that could be used to separate a bear from a rabbit, but none of those may help differentiate between two bears.

In an embodiment, the computer will utilize the image from the imaging device (201) to attempt to locate a toy (101) in the field of view and, once the toy (101) is located, will attempt to “lock-in” to the toy (101) in the field of view to allow the computer to track the toy (101) and to look for additional information. This can often allow the computer to quickly narrow the recognition down to a small subset of toys, and to then search for any of a number of characteristics that would allow a more definitive determination of the toy. Often, the identification of the toy (101) initially will be through a color and/or pattern match. As plush toys are often in a specific group of colors (many of which are not particularly common), identifying an object that matches a particular color or pattern of a toy is a good indicator that a toy has been found.

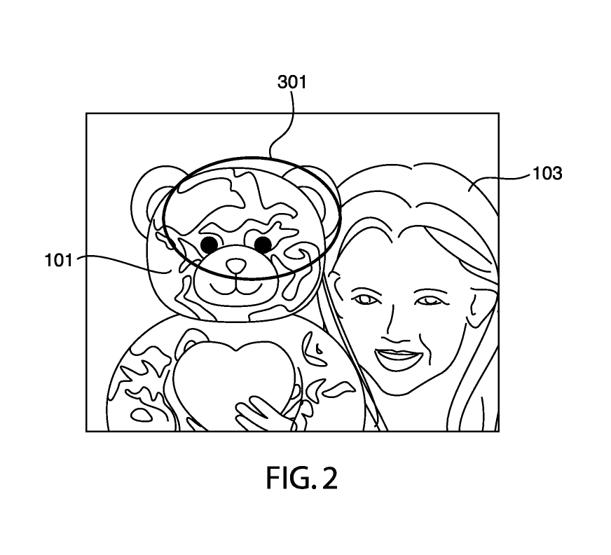

FIG. 2 provides for an image from an image device showing a toy (101) in the field of view. There is also a child (103) holding the toy (101). The circle (301) shows a section of the image that the computer has locked-in as being identified as having a pattern from a toy database associated with the recognition system as indicating a toy (101).

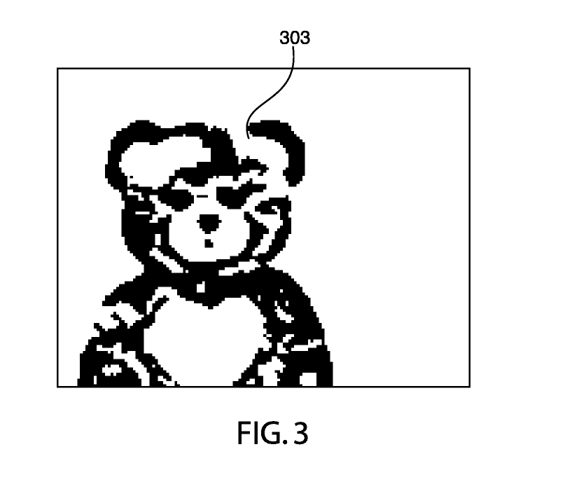

FIG. 3 provides for a “recognition” view of the computer. FIG. 3 shows what the computer has identified as possibly a matching color pattern (303). As should be apparent, the pattern (303) visible in FIG. 3 is larger than the locked-in pattern. In an embodiment, the computer may review this detected pattern for other cues of information. For example, in this FIG. 3 the shape of the ear is clear, further so is the size, length, and color of the nose, and the facial positioning of the eyes and nose buttons. From examination of FIG. 3, it should be apparent that any or all of these additional variables could be used to determine that this is a “teddy bear” toy of the particular color and pattern that was locked-in. This is true even though none of those secondary characteristics was specifically in the locked-in selection. However, by locking in the color pattern, and then searching out that pattern and neighboring areas, the additional elements are easily found.

As was discussed above, a child (103) will rarely hold the toy (101) still. Thus, the ability to lock-in and track a portion of an object which has been identified as a toy (e.g., because of its color and/or pattern) can also allow the computer to track the toy (101) as it moves. Thus, the computer may get information as different parts of the toy (101) become visible.

In order to get the computer to recognize and identify the toys (101) which it may see, it is generally necessary to load a database accessible by the computer with possible toys (101). In an embodiment, this is done by providing a plurality of pictures of a toy (101) to the database to serve as a template. The pictures of the toys (101) can then be converted to a pattern form, and the computer can seek out particular unique portion of the pattern that are specific to one toy (101) or another, as well as those that are common between toys (101) or strongly indicative of a toy generally (101). These “elements” can then be used to look for matches when a toy (101) is presented by child (103). Thus, if a match is found for a particular color pattern common between three toys, the system can now look for an element that will segregate those specific three toys. In this way, a pattern which is common among a toy in the selected group (and one that is not) can still be used to determine the particular toy. For example, if the group of toys of a particular color pattern only includes one bear, an element which is common across a multitude of different bears may now become the most valuable element in identification, even though, if the color was not known, this element may serve to only reduce the possible toys by a small number.

It is preferred that the plurality of pictures used to train the database include enough views of the toy (101) that there is unlikely to be any part of the toy (101) which has not been imaged. Thus, it is unlikely that a valuable identification element would not otherwise be known as valuable for identification. The computer can generally identify the presence of the toy from any direction and there will rarely be any position that the toy (101) can be held without there being sufficient characteristics visible to make a fairly accurate determination of which toy (101) it is. Further, if images are provided at different distances, then one can look for pattern that may be present at one distance but not another.

The training images can come from a variety of different sources. In an embodiment, the images can be provided by taking high quality images of the toys (101) with a neutral background and under specific light conditions. This type of input is often preferred as it allows for variables to be controlled. For example, a particular plush toy (101) may have a different color under natural sunlight than it will have under fluorescent store lighting. Thus, if a particular light source is used for the photograph, effects of other lighting can be compensated for based on known differences. Similarly, when controlled photographs are used, there is less chance that the system will inadvertently view something in the background and take that to be part of the toy (101).

Alternatively to having well prepared photographs, the imaging device (201) itself may be used in an alternative embodiment. For example, the imaging device (201) could be set in a program mode and then various toys (101) could be provided in the field of view. The toys (101) could be moved and rotated while the imaging device (201) is in a recording mode and can be provided in various orientations. In this scenario, local effects (such as lighting) do not need to be compensated for because the toy (101) is already present under these conditions. Further, the system will be provided with the same quality level of input as it would receive when operating in an identification mode, and thus details which may not be visible (based on the resolution of the available imaging system) do not become part of the database. This can eliminate extraneous information or patterns which should not be matched. However, it will often require that the toy database be entered locally to every station (100) while the first methodology can be used to provide a more central database which each station (100) can utilize subject to its own set of local compensation values.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A station for providing an interaction with a plush toy, the station comprising:
an imaging device;
a screen; and
a computer having access to a database of plush toys;
wherein, when a plush toy is presented to said imaging device, said computer compares said image against said database and locates a match; and
wherein, when a match is detected, said screen displays content specific to said plush toy.

2. The station of claim 1 further comprising a speaker.

3. The station of claim 2 wherein, when a match is detected, said speaker vocalizes content specific to said plush toy.
